(19) United States
(12) Patent Application Publication
(10) Pub. No.: US 2005/0125783 A1
(43) Pub. Date: Jun. 9, 2005

(54) Program optimization with intermediate code

(75) Inventors: Reid Edmund Tatge, Missouri City, TX (US); Alan Lee Davis, Sugarland, TX (US); Alan Scott Ward, Sugarland, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/731,766

(22) Filed: Dec. 9, 2003

(51) Int. Cl. G06F 9/45

(52) U.S. Cl. 717/152

(57) ABSTRACT

In some embodiments, a code generating system comprises a compiler that receives source code written in a high-level programming language and generates object code and intermediate code. In addition, the code generating system comprises a linker that receives the object code and the intermediate code and sends the intermediate code to a code optimizer that is coupled to the compiler. In some embodiments, the intermediate code generated by the compiler is stored in a magnetic storage device before being sent to the linker. In other embodiments, the intermediate code is stored in non-volatile memory before being set to the linker.

### BACKGROUND OF THE INVENTION

1. Technical Field of the Invention

The present invention relates generally to optimizing code written in a high level programming language.

2. Background Information

Many types of devices require embedded programs for the operation of the device. Such devices may include cellular phones and personal organizers. The embedded programs may be created with multiple source files that are written in a high level programming language (e.g., C, Java). The source files may be compiled by a compiler and then executed by a microprocessor. While being compiled, a program optimization procedure may occur in the compiler that increases the performance of the program. Typically, the whole program optimization procedure requires access to all of the source files associated with the program. However, all of the source files may not be readily available because part of the program is represented as pre-compiled, object code in libraries.

### BRIEF SUMMARY

In some embodiments, a code generating system comprises a compiler that receives source code written in a high-level programming language and generates object code and intermediate code. In addition, the code generating system comprises a linker that receives the object code and the intermediate code and provides the intermediate code to a code optimizer that is coupled to the compiler. In some embodiments the intermediate code generated by the compiler is stored with the object code generated by the compiler. The linker uses the intermediate code stored with the object code to effect optimizations that would otherwise not be possible using the object code alone.

### Notation and Nomenclature

Certain terms are used throughout the following description and claims to refer to particular system components. As one skilled in the art will appreciate, various companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

### BRIEF DESCRIPTION OF THE DRAWINGS

For a more detailed description of the preferred embodiments of the present invention, reference will now be made to the accompanying drawings, wherein:

FIG. 1 illustrates a code generating system in accordance with preferred embodiments of the invention;

FIG. 2 illustrates a compilation procedure in accordance with preferred embodiments of the invention; and

FIG. 3 illustrates an exemplary computer system in accordance with preferred embodiments of the invention.

### DETAILED DESCRIPTION OF THE PREFERRED EMBODIMENTS

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

The subject matter disclosed herein is generally directed to a whole program optimization procedure associated with a code generating system. The code generating system converts source files written in a high-level programming language into executable files that may by executed by a microprocessor. Merely by way of example, the embodiments described herein are directed to a C code generating system.

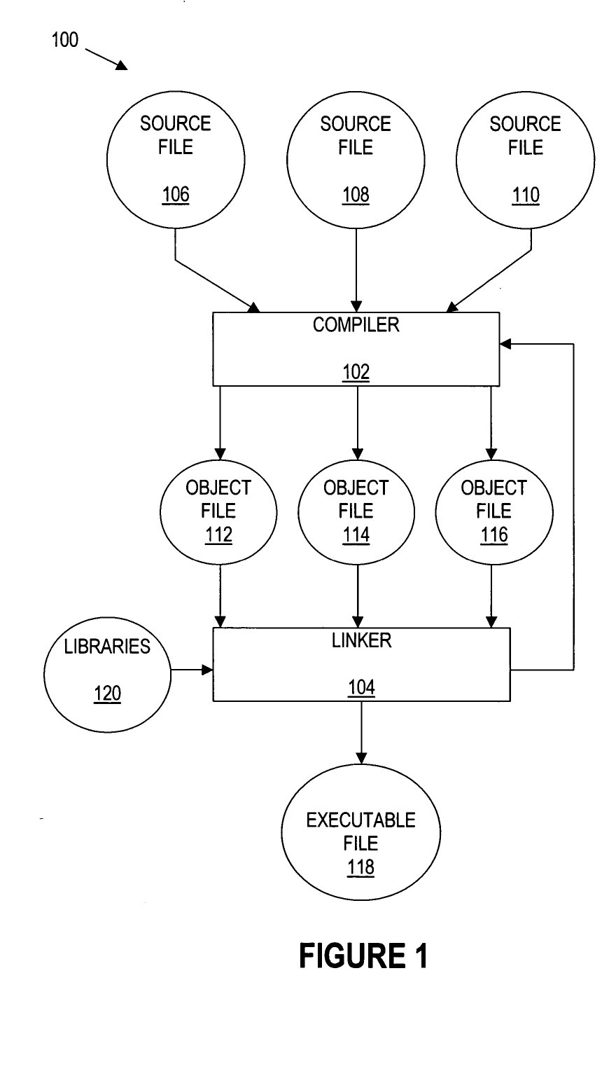

Referring now to FIG. 1, an exemplary code generating system 100 is shown in accordance with a preferred embodiment of the invention. As shown, the code generating system 100 includes a compiler 102 and a linker 104. The compiler 102 preferably compiles source files written in a high-level programming language into object files. Although any number of source files may be compiled by the compiler 102, three source files 106, 108, and 110 are shown in the exemplary embodiment of FIG. 1 to facilitate discussion. The source files 106, 108, and 110 may comprise a program to be executed on a microprocessor.

The compiler 102 and the linker 104 preferably are implemented in software that may be executed by a microprocessor. The software may comprise numerous executable modules that process data. Typically, the compiler 102 processes an input to produce an output. The output then may be provided to the linker 104.

The compiler 102 may compile the three source files 106, 108, and 110 into three object files 112, 114, and 116, respectively. Although the source files may be compiled together, each source file 106, 108, and 110 preferably is compiled by the compiler 102 at separate times. The object files 112, 114, and 116 produced by the compiler 102 may include object code and intermediate code. In general, intermediate code is a representation of the source program in an abstract form suitable for optimization. Object code is a representation of the source program in a low-level binary form suitable for execution. The linker 104 preferably takes the three objects files 112, 114, and 116 and one or more libraries 120 to produce an executable file 118. The libraries 120 comprise object and intermediate code previously compiled by a compiler. Before producing the executable file 118, the linker 104 may provide any intermediate code in the three objects files 112, 114, 116 and the library 120 back to the compiler 102 for optimization. The compiler 102 may generate optimized object code from this intermediate code. The optimized object code preferably is incorporated into the linker 104 to produce the executable file 118. The executable file 118 now may be executed by a microprocessor.

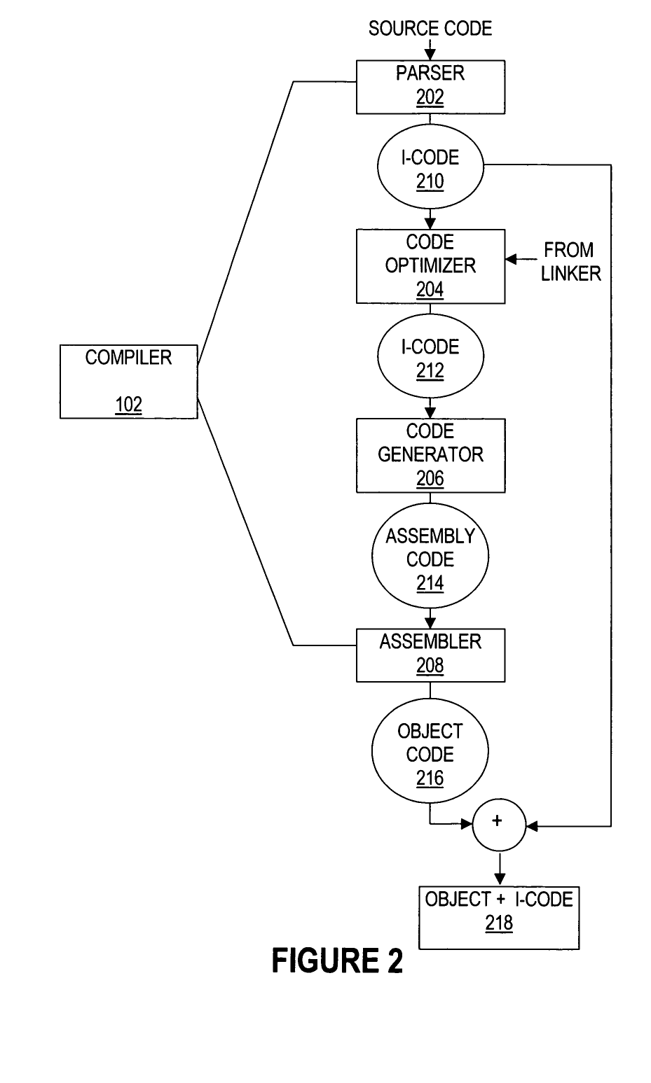

Referring now to FIG. 2, an exemplary compilation procedure is shown in accordance with the preferred embodiment of the invention. The compiler 102 preferably possesses four components, a parser 202, a code optimizer 204, a code generator 206, and an assembler 208. The parser 202 preferably receives a source file and verifies the syntax of the source file to ensure that the source file complies with the high-level programming language that it is written in. In addition, the parser 202 produces a representation of the source file, referred to as “intermediate code” 210 (I-Code). The intermediate code 210 preferably is a semantic representation that reveals the structure of the source program. For example, if the source program contains a loop, the intermediate code may represent the loop as a series of hierarchical operations based upon the structure of the loop.

The intermediate code 210 generated by the parser 202 preferably is provided to the code optimizer 204. The code optimizer 204 may use various optimization algorithms to optimize the intermediate code 210. The output of the code optimizer 204 is optimized intermediate code 212.

In alternative embodiments, the intermediate code generated by the parser 202 may not be optimized by the code optimizer 204. In this alternative embodiment, the intermediate code is provided directly to the code generator 206.

In the preferred embodiment, the code generator 206 receives the intermediate code produced from the code optimizer 204 and preferably generates low-level machine code, such as assembly code 214 as shown in FIG. 2. The assembly code 214 contains operations referred to as “instructions” and associated arguments referred to as “operands.”

The final component of the compiler 102 is the assembler 208. The assembler 208 preferably assembles the assembly code 214 produced by the code generator 206 and produces object code 216. The object code 216 preferably contains low-level machine specific code, suitable for input to a linker or executed by a microprocessor. In alternative embodiments the code generator 206 may directly generate object code 216 and the assembler 208 is omitted.

In accordance with the preferred embodiment, the intermediate code 210 produced by the parser 202 may be merged with the object code 216 produced by the assembler 208 to produce an object plus intermediate code file 218. After the assembler 208 produces the object code 216, the intermediate code 210 that is preferably produced by the parser 202 is merged with the object code 216 to produce the object plus intermediate code file 218. The merging combines the intermediate code 210 and object code 216 into the single object plus intermediate code file 218. In alternative embodiments, the intermediate code 210 is appended to the file containing the object code 216 to produce the single object plus intermediate code file 218.

Referring again to FIG. 1, the object files 112, 114, and 116 preferably contain object plus intermediate code that was produced as a result of compiling the source files 106, 108, and 110, respectively. Thus the linker 104 may receive intermediate code as well as object code from the compiler 102.

Referring again to FIG. 1, during the linking process, the linker 104 may identify any object file 112, 114, and 116 that contains intermediate code, as well as libraries 122 that contain intermediate code. The intermediate code associated with these identified object files and libraries 122 preferably is combined together by the linker 104 and provided to the code optimizer 204 (FIG. 2) of the compiler 102. The code optimizer 204 now may perform program optimization on all of intermediate code sent from the linker 104. After optimizing the intermediate code, the compilation procedure preferably may continue by providing the optimized intermediate code 212 to the code generator 206 as discussed above. The new object code created by the assembler 208 preferably may replace the object code associated with the intermediate code identified by the linker 104. The linker 104 may link the now optimized object code to produce the executable file 118.

In other embodiments of the invention, the linker 104 may accept option flags that identify the program optimization to be performed. For example, if only object files 112 and 114 are desired to be optimized, the linker 104 may be invoked with option flags that inform the linker 104 to only combine the intermediate code associated with the two object files 112 and 114. This combined intermediate code may be passed to the code optimizer 204. In this case, the object code generated by the assembler 208 preferably replaces the object code associated with the object files 112 and 114, not the object code associated with object file 116.

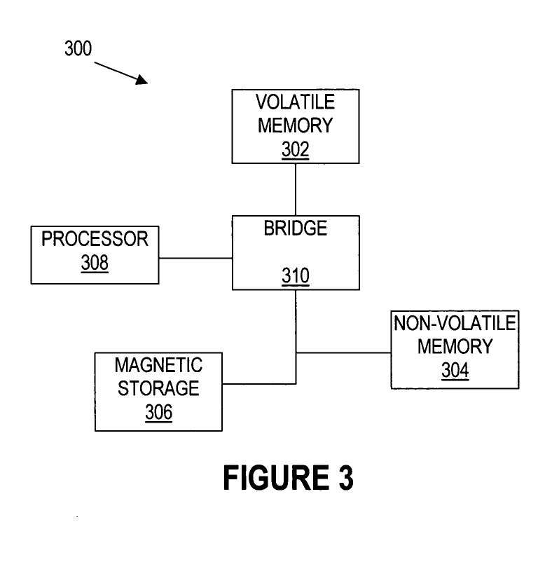

Referring now to FIG. 3, an exemplary computer system 300 is shown in accordance with the preferred embodiments. The system 300 may include three storage units, a volatile memory unit 302, a non-volatile memory unit 304, and a magnetic storage unit 306, and a processor 308. Preferably coupling the processor 308 and the storage units is a bridge 310. The bridge 310 may negotiate the transfer of data from the storage units to the processor 308 and the transfer of data between the storage units. The intermediate code 210 and the optimized intermediate code 212 may be stored on any one of the storage units, or a combination of the storage units, before being combined with the object code 216 to produce the object plus intermediate code file 218.

The preferred and alternative embodiments of the invention provide substantial benefits over other optimization procedures. For example, a typical program optimization procedure may require all the source files associated with the program. These source files may no longer exist or may not be readily available. In the preferred embodiments, the information needed by a code optimizer to optimize the program is included in the intermediate code stored with the object file. In the preferred embodiment these object files could be stored in libraries.

While the preferred embodiments of the present invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Accordingly, the scope of protection is not limited by the description set out above. Each and every claim is incorporated into the specification as an embodiment of the present invention.

1. A code generating system, comprising:
a compiler that receives source code and generates an object file comprising object code and intermediate code;
a code optimizer coupled to the compiler; and
a linker that receives the object file comprising object code and intermediate code and provides the intermediate code to the code optimizer.

2. The code generating system of claim 1 wherein the code optimizer produces optimized intermediate code that has been processed by a optimization algorithm.

3. The code generating system of claim 1 wherein the linker produces executable code.

4. The code generating system of claim 1 wherein the linker sends only portions of the intermediate code to the code optimizer.

5. The code generating system of claim 1 wherein the intermediate code generated by the compiler is stored in non-volatile memory.

6. The code generating system of claim 1 wherein the intermediate code generated by the compiler is stored in a magnetic storage device.

7. The code generating system of claim 1 wherein the object files comprising object code and intermediate code may comprise a library.

8. A method to optimize a program consisting of a plurality of source files, the method comprising:
producing intermediate code associated with one or more of the plurality of source files;
producing object code associated with one or more of the plurality of source files;
merging the intermediate code and the object code associated with each source file into an object file comprising object code plus intermediate code; and
optimizing the program by providing the intermediate code in the object file to a code optimizer.

9. The method of claim 8 wherein the producing intermediate code further comprises storing the intermediate code into a magnetic storage device.

10. The method of claim 8 wherein the producing intermediate code further comprises storing the intermediate code in non-volatile memory.

11. The method of claim 8 wherein optimizing the program further comprises receiving optimized intermediate code from the code optimizer and producing optimized executable code.

12. A storage medium containing instructions that are executed by a processor and comprising:
instructions that produce intermediate code from one or more source files;
instructions that produce object code from one or more source files;
instructions that merge the intermediate code and the object code associated with one of the source files into a single intermediate plus object code file; and
instructions that provide the intermediate code contained in the single intermediate plus object code file to a code optimizer.

13. The storage medium of claim 12 wherein the instructions that produce intermediate code further comprises instruction for storing the intermediate code into a magnetic storage device.

14. The storage medium of claim 12 wherein the instructions that produce intermediate code further comprises instruction for storing the intermediate code in non-volatile memory.

15. The storage medium of claim 12 wherein the instructions that produce intermediate code to a code optimizer further comprises instructions for producing optimized object code.

16. A computer system, comprising:
a processor,
memory coupled to the processor;
a code generating system stored in the memory and executable on the processor and that produces intermediate code and object code that is stored into a single intermediate plus object code file and provided to a code optimizer.

17. The computer system of claim 16 wherein the intermediate code produced by the code generating system is stored into a magnetic storage device.

18. The computer system of claim 16 wherein the intermediate code produced by the code generating system is stored into non-volatile memory.
